(19) United States
(12) Patent Application Publication
(10) Pub. No.: US 2006/0151762 A1
(43) Pub. Date: Jul. 13, 2006

(54) CABLE OR ROD GRIPPING APPARATUS

(76) Inventor: Gerald Robinson, Burnaby (CA)

Correspondence Address: VERMETTE & CO., BOX 40, GRANVILLE SQUARE, SUITE 230 - 200 GRANVILLE STREET, VANCOUVER, BC, V6C 1S4, CA

(21) Appl. No.: 10/908,319

(22) Filed: May 6, 2005

(30) Foreign Application Priority Data
Sep. 1, 2004 (CA) 2,480,133

(51) Int. Cl. B25B 25/00

(52) U.S. Cl. 254/245

(57) ABSTRACT

A cable and rod gripping apparatus which includes a base, a pair of linkages pivotally mounted on said base and a gripping pad pivotally mounted on a distal end of each of said linkages in opposition to each other so that upon pivoting together the pads contact the cable or the rod above a position of alignment of the linkages and move together until gripping said cable or rod while still above the position of alignment.

### FIELD

The present invention relates to an apparatus for gripping a cable or rod in response to tension on the cable and for releasing the cable automatically in response to removal of the tension, all without damaging the cable.

### BACKGROUND

Conventional devices for gripping cables have gripping pads, one of which tends to dig into and become locked onto the cable when the cable is under tension. Usually, when the cable tension is released, it is necessary to hammer the pad which is locked onto the cable free. The digging into the cable and the hammering on the pad to release it cause damage to the cable. Eventually, such damage necessitates a costly replacement of the cable.

Another conventional device utilizes a pair of hydraulic cylinders to release the pads from the cable. The use of two such devices introduces a high level of complexity at a location which is not always easy to access.

### SUMMARY OF THE INVENTION

According to the invention there is provided a cable and rod gripping apparatus which includes a base, a pair of linkages pivotally mounted on said base and a gripping pad pivotally mounted on a distal end of each of said linkages in opposition to each other so that upon pivoting together the pads contact the cable or the rod above a position of alignment of the linkages and move together until gripping said cable or rod while still above the position of alignment.

One of the pads may have a profile that matches that of the cable while another of the pads has semicircular cable gripping surface with circular grooves that slip over a cable.

Preferably, a length “a” of the linkages is 4½ inches.

A distance “b” above alignment of the linkages may, advantageously, be ¼ inches.

A pair of hydraulic piston cylinders may be attached to the base and be operative to move the base and release the pads from gripping the cable.

### BRIEF DESCRIPTION OF THE DRAWING

FIG. 1 is a front elevation view of the gripping apparatus with an untensioned cable;

FIG. 2 is a perspective view of one of two gripping pads;

FIG. 3 is a perspective view of the second of the two gripping pads; and

FIG. 4 is a front elevation view of the gripping apparatus with a tensioned cable.

### DETAILED DESCRIPTION WITH REFERENCE TO THE DRAWINGS

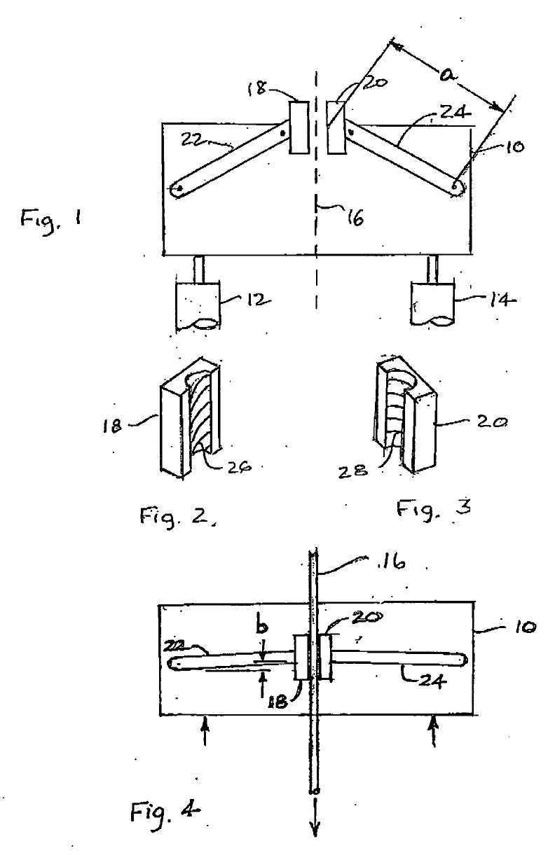

Referring to FIG. 1, a frame assembly 10 supports a pair of linkage arms 22 and 24 at a distal end of which are respective pads 18 and 20. Pads 18 and 20, which are made of hardened steel, surround a cable 16 shown in FIG. 1 only as a dotted line. Linkage arms 22 and 24 are pivotally attached to frame 10 at one end and pivotally attached to respective pads 18 and 20 at the other end. Hydraulic piston cylinders 12 and 14 attach to the frame 10 and cause it to move downwardly as shown in FIG. 1 releasing the gripping jaws 18 and 20 from the cable 16. Next tensioning of the cable 16 causes the pads 18 and 20 to begin gripping the cable 16 again. An optimal length of linkage arms 22 and 24 is 4½ inches. They are pivotally mounted so that the pads engage the cable with the distance b at approximately 1½ inches above the position of alignment of linkage arms 22 and 24 and continue to move down until they are about ¼ inch above the position of alignment aforesaid.

As seen in FIG. 2, pad 18 has a rounded jaw region which matches the diameter of the cable 16 as well as having helical grooves 26 which match the windings of the cable 16 and contact the cable 16 in a non-slip engagement. Pad 20 shown in FIG. 3 also has a rounded jaw region but has horizontal grooves 28 which tend to slip over the cable 16. Thus, pads 18 and 20 cannot grip the cable at different locations as only pad 18 determines the position for locking engagement.

Once pads 18 and 20, as shown in FIG. 4, have gripped the tensioned cable 16, the entire assembly 10 is pulled along by the cable. Release of the pads is achieved by using the hydraulic cylinders 12 and 14 to pull the frame towards them so that pads 18 and 20 release from the cable 16. Because of the shape of the jaws and the matching grooves in pad 18 and groove pattern of pad 20, no damage is done to the cable during this process.

The present system has application wherever it is desired to move a heavy load attached at an end of the cable 16. In the case that the frame assembly is attached to the rear of a tow truck (not shown) moving the tow truck towards the top of the drawing of FIG. 1 moves the weight. Should the tow truck wish to release from the load and reposition itself it merely backs up taking the tension off of the cable 16 and the pads 18 and 20 automatically release. Another application is pulling a replacement pipe through a burst underground pipe.

The gripping apparatus can also be used to pull rods rather than cable. In the latter case the pad 18 would be replaced by one, which has horizontal grooves as does pad 20.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

1. A cable and rod gripping apparatus, comprising:
(a) a base;
(b) a pair of linkages each pivotally mounted on said base with spaced apart pivot axes that are parallel and located at respective pivot ends of said linkages; and
(c) a gripping pad pivotally mounted on a distal end of each of said linkages remote from the pivot end with a gripping pad pivot axis oriented in a direction parallel to the pivot axes of said linkages, said linkages pivotal from a position in which said linkages are aligned and said gripping pads are remote from each other to a position in which said linkages are aligned or nearly aligned and said gripping pads are in contact with or in close proximity to each other, said gripping pads contacting said cable or said rod just before reaching a position of alignment of said linkages and upon engagement of said gripping
(d) pads with said cable or rod, tensioning said cable or pulling on said rod in a direction tending to bring said linkages into alignment increases friction between said gripping pads and said cable or rod.

2. An apparatus according to claim 1, wherein one of said gripping pads has a profile that matches the grooves of said cable while another of said gripping pads has a semicircular cable gripping surface with circular grooves that slip over a cable.

3. An apparatus according to claim 1, wherein a length “a” of said linkages is 4½ inches.

4. An apparatus according to claim 1, wherein a distance “b” above alignment of said linkages is ¼ inches.

5. An apparatus according to claim 1, including a pair of hydraulic piston cylinders attached to said base and operative to move said base and release said gripping pads from gripping said cable.
